(19) United States
(12) Patent Application Publication
(10) Pub. No.: US 2011/0053507 A1
(43) Pub. Date: Mar. 3, 2011

(54) APPARATUS AND METHOD FOR IMPROVING BLUETOOTH COMMUNICATION PERFORMANCE IN MOBILE TERMINAL

(75) Inventor: Woo-Sung CHOI, Seoul (KR)

(73) Assignee: SAMSUNG ELECTRONICS CO. LTD., Suwon-si (KR)

(21) Appl. No.: 12/872,093

(22) Filed: Aug. 31, 2010

(30) Foreign Application Priority Data
Sep. 2, 2009 (KR) 10-2009-0082473

(51) Int. Cl. H04B 7/00

(52) U.S. Cl. 455/41.2

(57) ABSTRACT

An apparatus and a method for maintaining a communication connection by increasing a transmission bandwidth of voice data and changing a compression rate depending on a Bluetooth communication state to transmit voice data in order to improve Bluetooth communication performance are provided. The apparatus includes a device connector. The device connector increases a transmission bandwidth of voice data by transmitting voice data through an Asynchronous Connection-Less (ACL) link during data transmission when transmitting voice data via a Bluetooth apparatus.

### PRIORITY

This application claims the benefit under 35 U.S.C. §119(a) of a Korean patent application filed in the Korean Intellectual Property Office on Sep. 2, 2009 and assigned Serial No. 10-2009-0082473, the entire disclosure of which is hereby incorporated by reference.

### BACKGROUND OF THE INVENTION

1. Field of the Invention

The present invention relates to an apparatus and a method for connecting via Bluetooth communication in a mobile terminal. More particularly, the present invention relates to an apparatus and a method for maintaining a communication connection by increasing a transmission bandwidth of voice data and changing a compression rate depending on a Bluetooth communication state, to transmit voice data with improved Bluetooth communication performance.

2. Description of the Related Art

The now ubiquitous mobile terminal has become indispensable to modern people, and service providers and terminal manufacturers competitively develop products (or services) for differentiation from one another.

For example, the mobile terminal has evolved into a multimedia apparatus that can provide one or more of a phonebook, games, a Short Message Service (SMS), Electronic (E)-mail, a Motion Picture Expert Group Audio Layer-3 (MP3) player, a digital camera, a wireless Internet service, various services, and the like.

Furthermore, the mobile terminal may enable a short range communication between terminals that are closely located to one another.

As an example of the above short range communication, the mobile terminal may provide various services such as a headset, music, printing, file transmission, and the like using a Bluetooth function.

The Bluetooth function is a communication technique for use by terminals located a short distance apart that include Bluetooth apparatuses for wirelessly communicating within a narrow range at low cost. In other words, the mobile terminal transmits/receives voice and data without a physical cable during communication between Bluetooth apparatuses located a short distance apart using a Radio Frequency (RF).

In the Bluetooth function, voice information is transmitted via a Synchronous Connection-Oriented (SCO) link, and data information is transmitted via an Asynchronous Connection-Less (ACL) link.

Only one SCO link may exist and a transmitted SCO packet is not retransmitted. Accordingly, a real-time characteristic is achieved but sound quality deterioration may occur.

Additionally, the SCO link limits a transmission bandwidth of voice data to 64 kbps. Accordingly, sound quality of voice data cannot be improved.

Furthermore, the mobile terminal only supports one headset. Thus, use of two or more headsets is not possible.

Therefore, an apparatus and a method for improving Bluetooth performance by addressing the above shortcomings are desired.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for increasing a transmission bandwidth of voice data when performing Bluetooth communication in a mobile terminal.

Another aspect of the present invention is to provide an apparatus and a method for connecting to a plurality of Bluetooth apparatuses to transmit voice data when performing Bluetooth communication in a mobile terminal.

Still another aspect of the present invention is to provide an apparatus and a method for maintaining a communication connection by changing a data compression rate depending on a Bluetooth communication state when performing Bluetooth communication in a mobile terminal.

In accordance with an aspect of the present invention, an apparatus for improving Bluetooth communication performance in a mobile terminal is provided. The apparatus includes a device connector for transmitting voice data through an Asynchronous Connection-Less (ACL) link during data transmission when transmitting voice data via a Bluetooth apparatus.

In accordance with another aspect of the present invention, an apparatus for improving Bluetooth communication performance in a mobile terminal is provided. The apparatus includes a device connector for transmitting voice data to a plurality of Bluetooth apparatuses through an ACL link during data transmission when transmitting voice data via a Bluetooth apparatus, wherein the device connector comprises a data compressor for maintaining a communication connection after the ACL link is established by establishing the ACL link and then changing a compression rate of the voice data depending on a Bluetooth communication state.

In accordance with yet another aspect of the present invention, a method for improving Bluetooth communication performance in a mobile terminal is provided. The method includes transmitting voice data through an ACL link during data transmission when transmitting voice data via a Bluetooth apparatus.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings in which:

FIG. 1 is a block diagram illustrating a mobile terminal for improving Bluetooth communication performance according to an exemplary embodiment of the present invention; and

FIG. 2 is a flowchart illustrating a process for transmitting data through Bluetooth communication in a mobile terminal according to an exemplary embodiment of the present invention.

Throughout the drawings, like reference numerals will be understood to refer to like parts, components, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide an apparatus and a method for maintaining a communication connection by increasing a transmission bandwidth of voice data and changing a data compression rate depending on a Bluetooth communication state in order to improve Bluetooth communication performance. The above mobile terminal increases a transmission bandwidth of voice data and connects to a plurality of Bluetooth apparatuses to enable transmission of voice data.

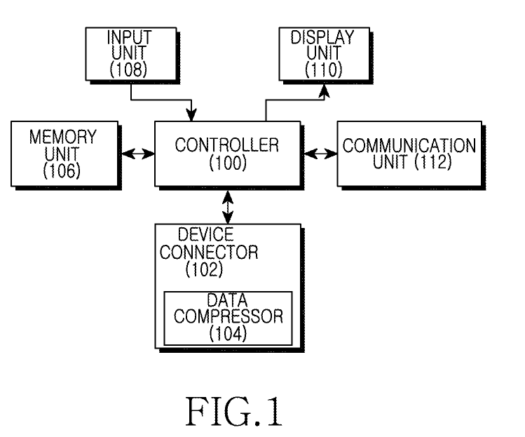

FIG. 1 is a block diagram illustrating a mobile terminal for improving Bluetooth communication performance according to an exemplary embodiment of the present invention.

Referring to FIG. 1, the mobile terminal includes a controller 100, a device connector 102, a memory unit 106, an input unit 108, a display unit 110, and a communication unit 112. The device connector 102 may include a data compressor 104. The portable terminal may include additional units. Similarly, the functionality of two or more of the above units may be integrated into a single component.

The controller 100 of the mobile terminal controls overall operations of the mobile terminal. For example, the controller 100 controls a process for voice communication and data communication. In addition to the overall operations, according to an exemplary embodiment of the present invention, the controller 100 increases a transmission bandwidth of voice data, and changes a compression rate depending on a Bluetooth communication state to transmit voice data with improved Bluetooth communication performance, thereby maintaining a communication connection.

Additionally, according to an exemplary embodiment of the present invention, the controller 100 may connect to a plurality of Bluetooth apparatuses to transmit voice data by increasing a transmission bandwidth of the voice data.

The controller 100 is described in more detail below.

First, to increase the transmission bandwidth of the voice data, in the case of transmitting the voice data to a counterpart mobile terminal through Bluetooth communication, the controller 100 establishes a Bluetooth connection through an Asynchronous Connection-Less (ACL) link which has been used by the conventional mobile terminal to transmit data, but not voice, in order to enable a point-to-multipoint access. That is, the controller 100 connects to a plurality of Bluetooth apparatuses via the ACL link that supports multiple channels to process the same data and different data of various types.

Additionally, the controller 100 of the mobile terminal, monitors the Bluetooth communication state and changes a compression rate, depending on the Bluetooth communication state, of thee voice data transmitted via the Bluetooth connection. If it is determined that the Bluetooth communication state is sufficient, the controller 100 compresses data without changing a compression rate. In contrast, if it is determined that the Bluetooth communication state is poor, the controller 100 changes the compression rate to reduce a transmission rate, in order to maintaining the communication connection.

To improve Bluetooth communication performance, the device connector 102 increases a transmission bandwidth of the voice data using voice data transmission via an ACL link, and changes a compression rate depending on a Bluetooth communication state to transmit voice data under control of the controller 100, thereby maintaining a communication connection.

The data compressor 104 of the device connector 102 changes the compression rate depending on the Bluetooth communication state to maintain a communication connection under the control of the device connector 102.

The memory unit 106 includes, for example, a Read Only Memory (ROM), a Random Access Memory (RAM), a flash ROM, and the like. The ROM may store microcode (i.e., code) of programs for processes and control of the controller 100 and the device connector 102, and various reference data.

The RAM serves as a working memory of the controller 100 and stores temporary data that occurs during execution of various programs. The flash ROM stores various updatable data for storage such as a phonebook, calling messages, received messages, and information of a user's touch input point.

The input unit 108 includes a plurality of function keys such as numerical key buttons of 0 to 9, a menu button, a cancel button, an OK button, a TALK button, an END button, an Internet access button, navigation key (or direction key) buttons, letter input keys, and the like. The input unit 110 provides key input data corresponding to a key pressed by a user to the controller 100. These keys are merely examples of keys which may make up the input unit 110. That is, the input unit may include additional or different keys, or different input mechanisms through which the user supplies input to the portable terminal

The display unit 110 displays status information generated during an operation of the mobile terminal, a limited number of letters, a large amount of moving images, still images, and the like. The display unit 110 may be a color Liquid Crystal Display (LCD), an Active Mode Organic Light Emitting Diode (AMOLED), and the like. The display unit 110 may include a touch input device, and when it is applied to a touch input type mobile terminal, it can be used as an input unit.

The communication unit 112 transmits/receives a Radio Frequency (RF) signal of data input/output via an antenna (not illustrated). For example, during transmission, the communication unit 112 channel-codes and spreads data to be transmitted, and then performs an RF process on the signal to transmit the signal. During reception, the communication unit 112 converts a received RF signal into a baseband signal, and despreads and channel-decodes the baseband signal to recover data.

The function of the device connector 102 may be performed by the controller 100 of the mobile terminal. Separate configuration and illustration of the device connector 102 is an example for convenience in description, and is not to be construed as limiting the scope of the present invention. It would be obvious to those skilled in the art that various modifications may be made within the scope of the present invention. For example, all functions of the device connector 102 may be processed by the controller 100.

An exemplary apparatus for maintaining a communication connection by increasing a transmission bandwidth of voice data and changing a data compression rate depending on a Bluetooth communication state in order to improve Bluetooth communication connection performance has been described above. An exemplary method for maintaining a communication connection by increasing a transmission bandwidth of voice data and changing a data compression rate depending on a Bluetooth communication state using the above-described apparatus according to an exemplary embodiment of the present invention is described below.

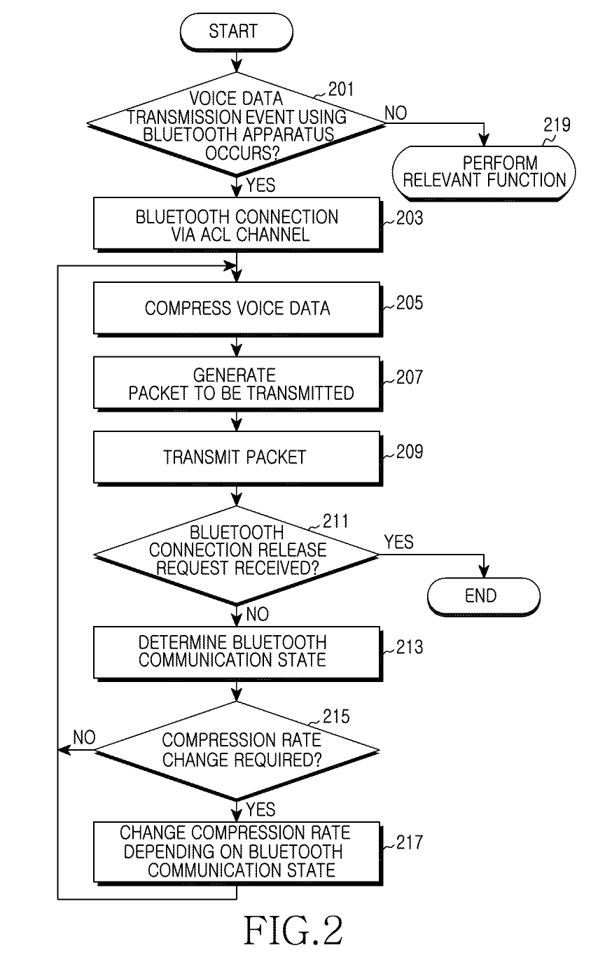

FIG. 2 is a flowchart illustrating a process for transmitting data through Bluetooth communication in a mobile terminal according to an exemplary embodiment of the present invention.

Referring to FIG. 2, the mobile terminal transfers voice via Bluetooth communication. The mobile terminal does not transfer voice data through a Synchronous Connection-Oriented (SCO) link as in the conventional mobile terminal. Instead, the mobile terminal transfers voice data through an ACL link to increase a transmission bandwidth of voice data and enable a communication connection with a plurality of Bluetooth apparatuses.

To perform the above-described operation, the mobile terminal according to an exemplary embodiment of the present invention determines whether an event for transmitting voice data using a Bluetooth apparatus, such as a headset, occurs in step 201.

If it is determined in step 201 that the event for transmitting voice data using the Bluetooth apparatus does not occur, the mobile terminal performs a relevant function (e.g., a standby mode) in step 219.

In contrast, if it is determined in step 201 that the event for transmitting voice data using the Bluetooth apparatus occurs, the mobile terminal performs a Bluetooth connection process through an ACL link in step 203.

At this point, according to an exemplary embodiment of the present invention, the mobile terminal determines a data transmission order using a Real-Time Transport Protocol (RTP) and a Real-Time Transport Control Protocol (RTCP), and compresses data to transmit the same, thereby performing voice data transmission through an ACL link that is performed during data transmission in the conventional mobile terminal to enable a point-to-multipoint access. That is, the mobile terminal addressed a data loss problem generated during voice data transmission that uses the ACL link supporting multiple channels through data transmission according to a data retransmission rate and a priority, and enables a connection with a plurality of Bluetooth apparatuses.

A mobile terminal for transmitting voice data through the ACL link compresses voice data in step 205, and generates a packet to be transmitted in step 207. Here, the mobile terminal may compress the voice data using a codec, such as G.723.1, depending on a user's voice quality. This raises transmission efficiency of a radio section to enable transmission of voice data via the ACL link. The compressed voice data is packetized by an RTP and prepared for transmission.

The mobile terminal that has compressed the voice data transmits the packet compressed and generated to raise transmission efficiency (in step 207) to a counterpart mobile terminal in step 209, and determines whether a request for releasing a Bluetooth connection that performs communication with the counterpart mobile terminal via the ACL channel is received in step 211.

When not receiving a request for releasing the Bluetooth connection with the counterpart mobile terminal in step 211, the mobile terminal determines whether communication with the mobile terminal is possible by determining a Bluetooth communication state based on an intensity of a reception signal in step 213.

The mobile terminal determines whether a compression rate change for a communication should be performed based on the Bluetooth communication state (performed in step 213) in step 215. At this point, when the Bluetooth communication state is determined to be poor, the mobile terminal changes a compression rate of voice data to maintain communication with the counterpart mobile terminal When the Bluetooth communication state once again becomes acceptable, the mobile terminal recovers the original compression rate to perform communication. This changes the compression rate depending on the Bluetooth communication state to enable real-time voice data transmission via the ACL link. The mobile terminal changes the compression rate using an RTCP for controlling an RTP.

If it is determined in step 215 that the Bluetooth communication state is improved and that communication with the counterpart mobile terminal is not impaired, the mobile terminal re-performs the process of step 205 to perform the Bluetooth communication with the counterpart mobile terminal.

In contrast, if it is determined in step 215 that the Bluetooth communication state is poor and the communication with the counterpart mobile terminal is impaired, the mobile terminal changes a compression rate depending on the Bluetooth communication state in step 217, and compresses voice data at the compression rate (changed in step 217) to generate a packet to be transmitted in step 205. The above-described process is performed until the Bluetooth connection with the counterpart mobile terminal is released.

That is, the mobile terminal raises a compression rate to a predefined compression rate to lower an amount of data being transmitted so that communication is possible when a Bluetooth communication state is poor, and lowers the compression rate which increases the amount of data being transmitted when the Bluetooth communication state improves. Accordingly, when the mobile terminal determines that the Bluetooth connection with the mobile terminal is released in step 211, the mobile terminal ends the present algorithm.

As described above, a mobile terminal according to an exemplary embodiment of the present invention may address a problem of the conventional mobile terminal that allows only one voice channel transmission by increasing a transmission bandwidth of voice data, and changing a data compression rate depending on a Bluetooth communication state to maintain a communication connection in order to improve performance of Bluetooth communication connection.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for improving Bluetooth communication performance in a mobile terminal, the apparatus comprising a device connector for transmitting voice data through an Asynchronous Connection-Less (ACL) link during data transmission when transmitting voice data via a Bluetooth apparatus.

2. The apparatus of claim 1, wherein the device connector comprises a data compressor for maintaining a communication connection after the ACL link is established.

3. The apparatus of claim 2, wherein the data compressor establishes the ACL link and then changes a compression rate of the voice data depending on a Bluetooth communication state to maintain a communication connection.

4. The apparatus of claim 3, wherein the data compressor changes the compression rate to reduce an amount of data being transmitted when it is determined that the Bluetooth communication state is poor after the transmitting of the voice data, and changes the compression rate to recover the amount of the data being transmitted when it is determined that the Bluetooth communication state improves.

5. The apparatus of claim 4, wherein the data compressor changes the compression rate of the voice data using a Real-Time Transport Control Protocol (RTCP).

6. The apparatus of claim 1, wherein the apparatus increases a transmission bandwidth of the voice data by transmitting the voice data via the ACL link.

7. The apparatus of claim 6, wherein the apparatus connects with a plurality of Bluetooth apparatuses by transmitting the voice data via the ACL link.

8. An apparatus for improving Bluetooth communication performance in a mobile terminal, the apparatus comprising:
a device connector for transmitting voice data to a plurality of Bluetooth apparatuses through an Asynchronous Connection-Less (ACL) link during data transmission when transmitting voice data via a Bluetooth apparatus,
wherein the device connector comprises a data compressor for maintaining a communication connection by establishing the ACL link and then changing a compression rate of the voice data depending on a Bluetooth communication state.

9. The apparatus of claim 8, wherein the data compressor changes the compression rate to reduce an amount of data being transmitted when it is determined that the Bluetooth communication state is poor after the transmitting of the voice data, and changes the compression rate to recover the amount of the data being transmitted when it is determined that the Bluetooth communication state improves.

10. The apparatus of claim 9, wherein the data compressor changes the compression rate of the voice data using a Real-Time Transport Control Protocol (RTCP).

11. The apparatus of claim 8, wherein the apparatus increases a transmission bandwidth of the voice data by transmitting the voice data via the ACL link.

12. A method for improving Bluetooth communication performance in a mobile terminal, the method comprising transmitting voice data through an Asynchronous Connection-Less (ACL) link during data transmission when transmitting voice data via a Bluetooth apparatus.

13. The method of claim 12, further comprising maintaining a communication connection after establishing the ACL link.

14. The method of claim 13, wherein the maintaining of the communication connection comprises changing a compression rate of the voice data depending on a Bluetooth communication state after establishing the ACL link.

15. The method of claim 14, wherein the changing of the compression rate of the voice data comprises:
when determining that the Bluetooth communication state is poor after transmitting the voice data, changing the compression rate to reduce an amount of data being transmitted; and
when determining that the Bluetooth communication state improves, changing the compression rate to recover the amount of the data being transmitted.

16. The method of claim 15, wherein the changing of the compression rate is performed using a Real-Time Transport Control Protocol (RTCP).

17. The method of claim 12, wherein a transmission bandwidth of the voice data is increased by transmitting the voice data via the ACL link.

18. The method of claim 17, wherein a connection with a plurality of Bluetooth apparatuses is enabled by transmitting the voice data via the ACL link.
